(19) United States
(12) Patent Application Publication
(10) Pub. No.: US 2010/0071252 A1
(43) Pub. Date: Mar. 25, 2010

(54) FISHING LURE

(76) Inventor: Warren WOODLEY, New South Wales (AU)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/563,318

(22) Filed: Sep. 21, 2009

(30) Foreign Application Priority Data
Sep. 22, 2008 (AU) 2008904928

(51) Int. Cl. A01K 85/16

(52) U.S. Cl. 43/42.35; 43/42; 43/42.36

(57) ABSTRACT

The invention relates to a fishing lure comprising a body member, the body member having an outer surface comprising one or more indentations and/or one or more protuberances. The indentations and/or protuberances located on the outer surface of the body member results in an increased bubble trail when the lure is pulled through water.

### TECHNICAL FIELD

The present invention relates to the field of fishing lures and more particularly to lures which produce an increased amount of bubbles when moving through water.

### BACKGROUND OF THE INVENTION

The use of lures is well known to fisherman, in particular game fisherman. There are potentially a number of characteristics of lures that are responsible for their appeal to fish. These characteristics include colour, shape, sound, motion and vibration.

It has been postulated that fish may also be attracted by trails of bubbles moving through the water. As such, a lure that is able to maximise the amount bubbles produced whilst travelling through the water is likely to be attractive to fish.

Against this background the present inventor has developed lures which, when moving through the water, are able to provide a significant bubble trail that has been found to enhance the lures' appeal to fish.

### SUMMARY OF THE INVENTION

In a first aspect, the present invention provides a fishing lure comprising a body member, the body member having an outer surface comprising one or more indentations and/or one or more protuberances.

The body member may comprise a plurality of indentations and/or protuberances.

The indentations and/or protuberances may be arranged in one or more rows on the outer surface of the body member.

The indentations and/or protuberances may be arranged in a plurality of rows on the outer surface of the body member.

The indentations and/or protuberances may be located across the entire outer surface of the body member.

The indentations and/or protuberances may be located in rows across the entire outer surface of the body member.

The indentations and/or protuberances may be of different sizes.

The one or more indentations may be dimples and/or channels.

The dimples may be concave in shape.

The one or more protuberances may be convex in shape.

The protuberances may be ribs or ridges or a combination thereof.

The body member may comprise a hollow portion that extends throughout the entire length thereof.

The body member may comprise first and second ends wherein the first end includes a base connected to an edge of the outer surface.

The base may be a concave surface.

The body member may be cylindrical in shape.

The lure may further comprise a skirt.

The skirt may be located at the second end of the body member.

The lure may comprise an attachment portion connected to the body member, the attachment portion facilitating attachment of the skirt to the body member.

A hook may be located adjacent to the second end of the body member when the lure is in use.

In an embodiment of the first aspect, the present invention provides a fishing lure comprising a body member of a cylindrical shape, the body member having an outer surface comprising a plurality of indentations, a skirt attached to an end of the body member, the body member further comprising a hollow portion that extends throughout the entire length thereof so as to allow attachment of the lure to a fishing line, and wherein the plurality of indentations are located across the entire outer surface of the body member.

### Definitions

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The articles “a” and “an” are used herein to refer to one or to more than one (i.e., to at least one) of the grammatical object of the article. By way of example, “an element” means one element or more than one element.

As used herein the term “dimple” is understood to mean an indentation or depression in a surface that may be for example round, square, triangular, cone-shaped or polygonal.

### BRIEF DESCRIPTION OF THE FIGURES

A preferred embodiment of the present invention will now be described, by way of example only, with reference to the accompanying drawings wherein:

FIG. 1 is a side view of a lure having a cylindrical shape and a plurality of indentations in the form of concave dimples.

FIG. 2 is a bottom view of the lure shown in FIG. 1.

FIG. 3 is a side view of an alternative lure having a cylindrical shape and a plurality of indentations in the form of concave dimples.

FIG. 4 shows a side view of an alternative lure having a cylindrical shape and a plurality of indentations in the form of concave dimples wherein the dimples are of two different sizes.

FIG. 5 is a side view of a lure including a skirt.

### DETAILED DESCRIPTION OF THE INVENTION

The present invention relates to a fishing lure comprising a body member, the body member having an outer surface comprising one or more indentations and/or protuberances.

The inventor has discovered that the presence of one or more indentations and/or protuberances located on the outer surface of the body member results in an increased bubble trail when the lure is pulled through water as compared to lures not having one or more indentations and/or protuberances on their body members. The increased bubble trail enhances the appeal of the lures to fish.

The body member may comprise a plurality of indentations and/or protuberances. In one embodiment, the body member comprises a plurality of indentations only.

The indentations and/or protuberances may be arranged randomly in any configuration on the outer surface of the body member, or alternatively may be arranged in an ordered manner, for example in the form of one or more rows. In one embodiment, the indentations and/or protuberances are arranged in a plurality of rows and/or columns.

The indentations and/or protuberances may be located across a substantial area of the outer surface of the body member. For example, the indentations and/or protuberances may be located across an area of between about 20% and about 60%, or between about 40% and about 60%, or between about 40% and about 70%, or between about 40% and about 95%, or between about 45% and about 85%, or between about 50% and about 85%, or between about 60% and about 85%, or between about 65% and about 85%, or between about 70% and about 85%, or between about 80% and about 95% of the total outer surface area of the body member.

The indentations and/or protuberances may be located across an area of the outer surface of the body member which is an area greater than about 50%, 60%, 70%, 80%, 90% or 95% of the total outer surface area of the body member.

The indentations and/or protuberances may be located across an area of the outer surface of the body member which is an area of about 50%, 60%, 70%, 80%, 90% or 95% of the total outer surface area of the body member.

The indentations may be one or more dimples and/or one or more channels (i.e. grooves or slots). The dimples may be of any shape for example round, square, triangular, cone-shaped or polygonal. In one embodiment, the dimples are concave in shape. The depth of the dimples and/or channels may be between about 1 mm and about 20 mm depending on the size of the body member. The dimples and/or channels may be of a uniform size, or alternatively may be of different sizes.

The protuberances may be of any shape, for example round, square, triangular, cone-shaped or polygonal. The protuberances may be convex in shape, or alternatively in the form of ribs or ridges, or a combination thereof.

The body member may comprise combinations of protuberances and indentations.

The body member may comprise first and second ends wherein the first end includes a base connected to an edge of the outer surface. The base may be a flat surface, or alternatively may be a concave surface.

The body member may be of a cylindrical shape, i.e a three dimensional object having two parallel circular bases connected by a curved surface. Alternatively, the body member may be of a rectangular, round or square shape, or some other shape.

The body member may comprise a hollow portion that extends throughout the entire length thereof. This hollow portion facilitates attachment of the lure to a fishing line. Alternatively, the lure may be attached to a fishing line by some other means, for example via one or more rings embedded in the body member.

The lure may further comprise a skirt. The skirt may render the lure more attractive to fish by giving it an appearance similar to a squid, cuttlefish bait fish or fish. The skirt may also contribute to the production of the bubble trail. In one embodiment, the skirt is located at the second end of the body member.

The lure may further comprise an attachment portion that is connected to the body member, the attachment portion facilitating attachment of the skirt to the body member. The attachment portion may comprise one or more curved surfaces, for example circular surfaces. The attachment portion may be one or more disc-like structures. In one embodiment, the attachment portion may further comprise a hollow portion in communication with the hollow portion of the body member such that the hollow portion of the body member and the hollow portion of the attachment member together form a hollow portion that extends throughout the entire length of the body member and the attachment member.

In use, a hook may be located adjacent to the second end of the body member. Where the lure comprises a skirt, the hook may be located within the skirt such that it is not ordinarily visible to a fish when the lure is in use.

The hook may be attached to a loop, the loop being attached to a line that travels through the hollow portion of the body member (and through the hollow portion of the attachment portion if present) and on to a fishing rod. The loop serves to attach the hook to the line whilst also preventing the lure from becoming removed from the line.

The body member, and where present the attachment portion, may be made of a is resilient material which tends to return to its original shape after manual manipulation. The body member may be hard or soft. The body member may be made from a material selected from the group consisting of: rubber, silicone, polyurethane, polyester, resin, metal or plastic. The lure may be formed of a single piece of resilient material.

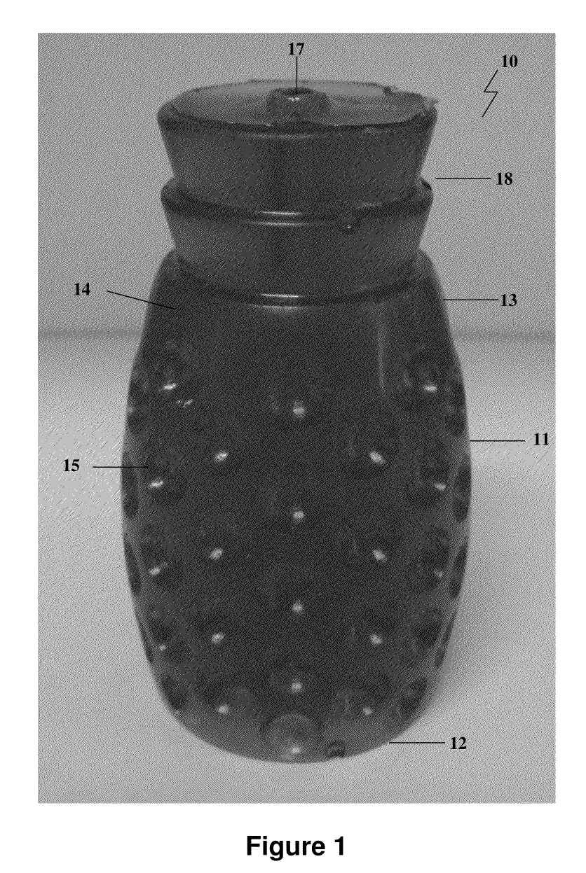

Referring to FIG. 1, lure 10 comprises body member 11 which is cylindrical in shape and includes first and second ends 12 and 13. Attachment portion 18 is connected (fused) to second end 13 and is comprised of two parallel circular surfaces wherein one is located above the other to which a skirt may be attached if desired. Attachment portion 18 comprises hollow portion 17 which extends throughout the entire length of the attachment portion 18. Body member 11 also comprises hollow portion 19 (not shown) in communication with hollow portion 17. Hollow portion 19 extends throughout the entire length of body member 11. Lure 10 further comprises an outer surface 14 comprising a plurality of concave dimples 15. The dimples 15 are arranged in a plurality of rows extending right the way around outer surface 14. As an alternative, the dimples 15 may be arranged in a plurality of rows that extend over approximately half, or over approximately three quarters of the outer surface 14.

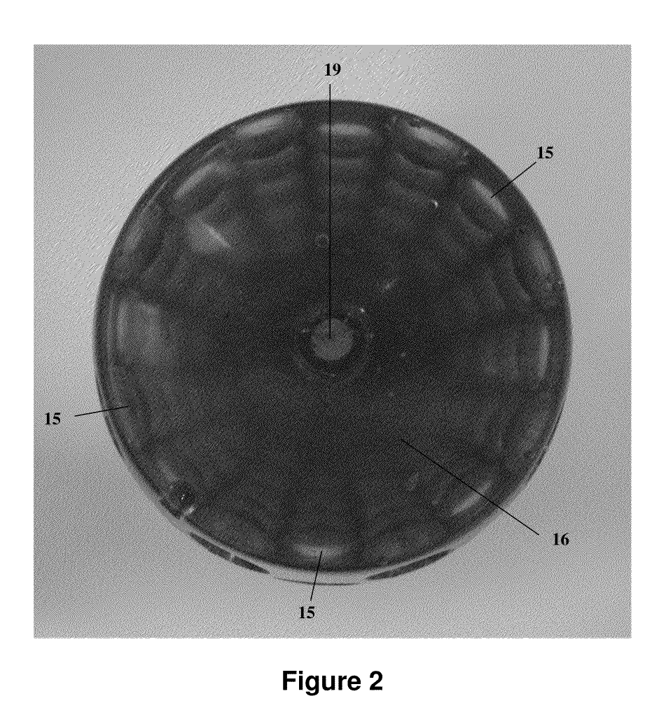

FIG. 2 shows a bottom view of the lure of FIG. 1 revealing the base 16 which is a concave surface, or alternatively may be a flat surface. Base 16 includes hollow portion 19 which extends throughout the entire length of body member 11, and is in communication with hollow portion 17.

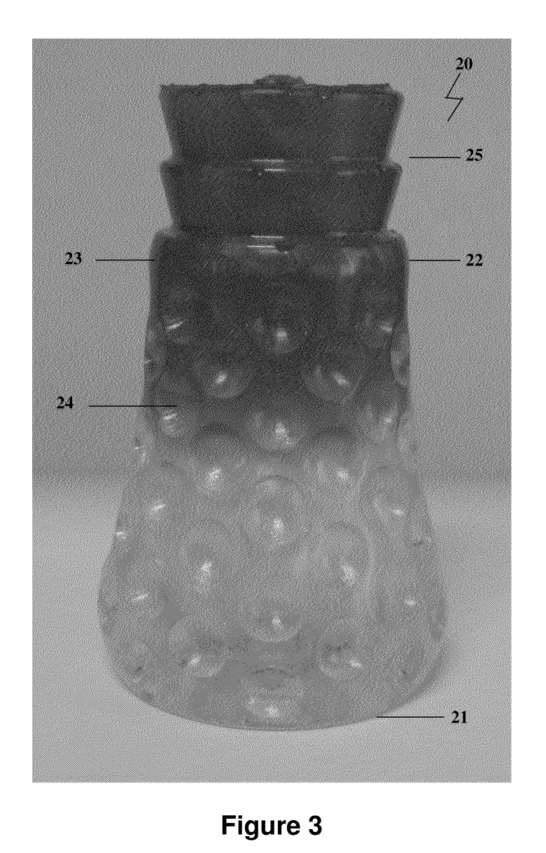

FIG. 3 shows an alternative lure 20 including first and second ends 21 and 22, wherein the first end 21 is of a larger circumference than the second end 22. Lure 20 comprises outer surface 23 which comprises a plurality of concave dimples 24, which are arranged in a plurality of rows extending right the way around outer surface 23. Lure 20 also comprises attachment portion 25 which is analogous to attachment portion 18 of lure 10 (see FIG. 1).

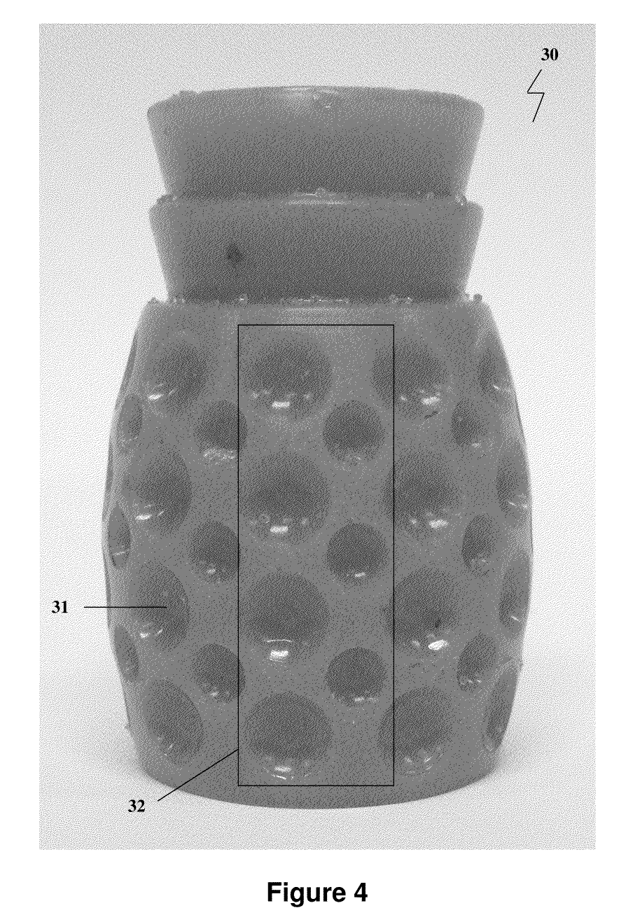

FIG. 4 shows a lure 30 in accordance with one embodiment of the invention comprising a plurality of concave dimples 31 arranged in a plurality of rows 32. The sizes of the dimples alternate between the respective rows.

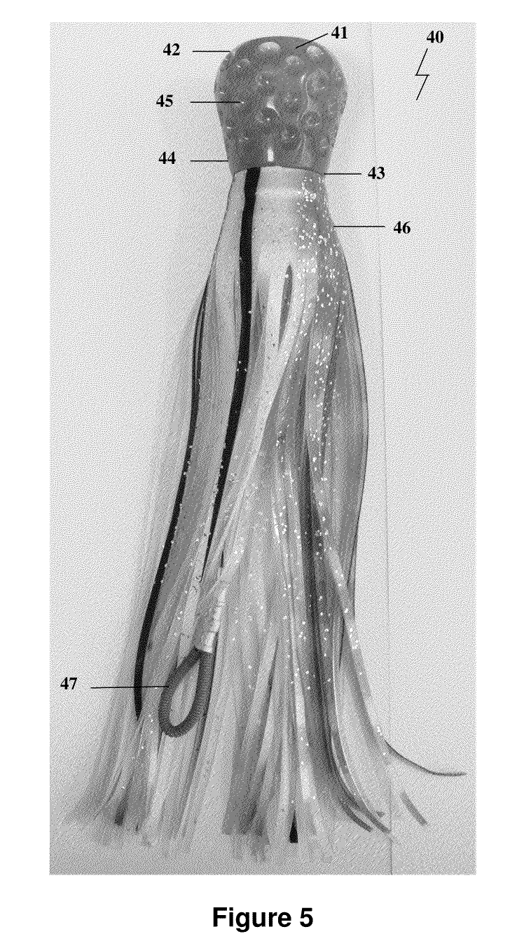

FIG. 5 shows a lure 40 comprising body member 41, which is of a bulbous cylindrical shape and includes first and second ends 42 and 43. Lure 40 further comprises an outer surface 44 comprising a plurality of concave dimples 45. The dimples are arranged in a plurality of rows extending right the way around outer surface 44. Lure 40 further comprises skirt 46 attached via an attachment portion (covered by the skirt hence is not shown) to the second end 43. The attachment portion is fused to the body member 41. Body member 41 and the attachment portion both comprise hollow portions (not shown) that extend throughout their entire lengths. In use, lure 40 cooperates with loop 47 which is connected to a line (not shown) which travels through the hollow portions of the body member 41 and attachment portion and on to a fishing rod. The loop 47 prevents the lure 40 from becoming removed from the line and also facilitates attachment of one or more hooks. When being pulled through the water, the hook(s) is located within the skirt 46 such that it is not ordinarily visible to a fish.

Those skilled in the art will appreciate that the invention described herein is susceptible to variations and modifications other than those specifically described. It is to be understood that the invention includes all such variations and modifications.

The claims defining the invention are as follows:

1. A fishing lure comprising a body member, the body member having an outer surface comprising one or more indentations and/or one or more protuberances.

2. The lure of claim 1, wherein the body member comprises a plurality of s indentations and/or protuberances.

3. The lure of claim 2, wherein the indentations and/or protuberances are arranged in one or more rows on the outer surface of the body member.

4. The lure of claim 2, wherein the indentations and/or protuberances are arranged in a plurality of rows on the outer surface of the body member.

5. The lure of claim 2, wherein the indentations and/or protuberances are located across the entire outer surface of the body member.

6. The lure of claim 5, wherein the indentations and/or protuberances are of different sizes.

7. The lure of claim 5, wherein the one or more indentations are dimples is and/or channels.

8. The lure of claim 7, wherein the dimples are concave in shape.

9. The lure of claim 5, wherein the one or more protuberances are convex in shape.

10. The lure of claim 5, wherein the protuberances are ribs or ridges or a combination thereof.

11. The lure of claim 5, wherein the body member comprises a hollow portion that extends throughout the entire length thereof.

12. The lure of claim 5, wherein the body member comprises first and second ends wherein the first end includes a base connected to an edge of the outer surface.

13. The lure of claim 12, wherein the base is a concave surface.

14. The lure of claim 12, wherein the body member is cylindrical in shape.

15. The lure of claim 12, further comprising a skirt.

16. The lure of claim 15, wherein the skirt is located at the second end of the body member.

17. The lure of claim 16, wherein an attachment portion is connected to the body member, the attachment portion facilitating attachment of the skirt to the body member.

18. The lure of claim 17, wherein in use a hook is located adjacent to the second end of the body member.
